(19) United States
(12) Patent Application Publication
(10) Pub. No.: US 2003/0118774 A1
(43) Pub. Date: Jun. 26, 2003

(54) Omnidirectional carpet tile and method

(76) Inventors: William Tippett, Ormskirk (GB); Vivien Lee, Halifax (GB); Carol A. Appleton, Ashton-in-Makerfield (GB)

Correspondence Address: Daniel R. Alexander, Legal Department, M-495, Milliken & Company, PO Box 1926, Spartanburg, SC, 29304, US

(21) Appl. No.: 10/304,448

(22) Filed: Nov. 26, 2002

(30) Foreign Application Priority Data
Nov. 30, 2001 (GB) GB 0128663.2

(51) Int. Cl. B32B 33/00

(52) U.S. Cl. 428/88; 428/89

(57) ABSTRACT

An omnidirectional carpet tile having a combination of omnidirectional pattern and non-directional pile enable carpet tiles to be laid in any orientation without pile effects.

### CROSS-REFERENCE TO RELATED APPLICATIONS

This application claims priority to and benefit of prior filed United Kingdom Patent Application Number GB 0128663.2, filed Nov. 30, 2001.

This invention relates to carpet tiles, particularly to omnidirectional carpet tiles, which can be laid and re-laid without regard to their orientation.

Carpet tiles are a convenient way to cover floors in domestic, commercial and public buildings. Conventionally, the tile has a pile direction that is set into the pile by the nature of the carpet tile face fabric formation process, for example, by a tufting and/or heat setting process. The directionality of the tile is often reinforced by the pattern applied to the tile face.

Carpet tiles are conventionally installed either monolithic, in which the pile direction of each tile lies the same way, quarter turn or checkerboard in which the pile directions of adjacent tiles are at right angles.

Many modern offices are carpeted with tiles that are laid over raised access floors. Access to the under floor area involves removal of the carpet tile or tiles, removal of the floor panels, and subsequent replacement of both floor panels and carpet.

The person re-installing the carpet tiles is frequently not trained in proper installation techniques, and usually the carpet tile is re-installed with random pile direction.

Modern pattern or design is often of an abstract or complex nature. Particularly interesting patterns can now be generated using computer design techniques. These patterns are themselves ‘omnidirectional’. That is they can, and should, be laid in various alignments. A problem with this is that for some pattern types the pile direction is visible and clearly shows that the tiles have not been laid in a single pile or process direction orientation. This unpleasant appearance is a limitation on the use of omnidrectional type patterning.

According to at least one embodiment of the present invention there is provided a carpet tile having an omnidirectional pattern together with an omnidirectional pile. Also, there is provided a system or plurality of such tiles.

This preferred construction provides the advantages that the full patterning effect can be achieved with a wide variety of base carpets and without differences in pile orientation showing during use or after cleaning with a vacuum cleaner.

In this invention, the base carpet tile has substantially no pile direction and has a pattern that is omnidirectional. This allows the product to be installed with random tile orientation, whilst maintaining a uniform appearance.

Pattern can be made by any method, for example dye-injection patterning, or tufting or weaving with dyed yarns.

Other advantages of the present invention are:

Use of omnidirectional patterns allows two or more carpet tile designs of different scale to be co-installed without a definite boundary between the designs. Pattern repeats are eliminated and photo-realistic images are not disrupted by modular format.

A random pile orientation of the type taught in U.S. Pat. No. 4,617,208 hereby incorporated by reference herein may be used, although the person skilled in the art will appreciate that the invention also encompasses other means to achieve non-directional or omnidirectional pile.

A typical omnidirectional pattern is taught in U.S. Pat. No. 5,959,632 hereby incorporated by reference herein. Again the person skilled in the art will appreciate that many other types of omnidirectional patterns or designs could also be utilised in the present invention.

### BRIEF DESCRIPTION OF THE DRAWINGS

FIG. 1 is a schematic plan view of two adjacent omnidirectional pile and omnidirectional pattern carpet tiles in accordance with one embodiment of the present invention.

### DETAILED DESCRIPTION OF THE INVENTION

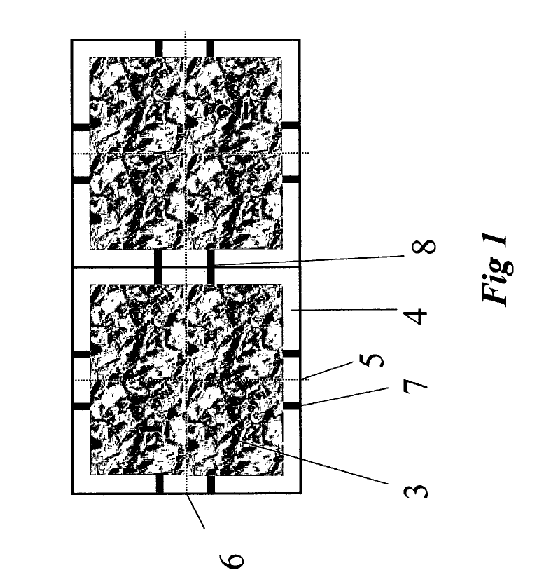

The invention will now be described by way of example only and with reference to FIG. 1, which is a plan schematic view of two adjoining omnidirectional pile carpet tiles with an omnidirectional pattern created according to the present invention.

Referring to FIG. 1, a carpet tile 1 is shown in abutting relationship to a second identical carpet tile 2. It will be appreciated that although the invention is described with reference to two identical carpet tiles, an advantage of this invention is that it gives the flexibility to fit together non-identical but complementary tiles as well as to turn individual tiles through angles of 90, 180 or 270 degrees. Each of the carpet tiles 1 and 2 is made from pile that is omnidirectional. By that it is intended to mean that the tile cannot be distinguished from its neighbour by reference to a pile direction after it has been turned.

Each tile has a central patterned area 3, which can be almost any graphical design chosen without regard for the need for omidirectionality. Around this central patterned area there is then defined a border area 4. The width of the border area may vary according to the nature of the pattern in area 3 but is typically about 5 to 10 mm. The tile itself is typically 400 mm square or larger.

Orthogonal lines of symmetry 5, 6 are shown on tile 1. The border area is created to be identical on each of the four sides of the tile and to be substantially symmetrical about the lines of symmetry. The need for each border area to be identical arises from the need to be able to lay the tile any way possible and the need for the symmetry arises from the need to fit the two tiles together. The border area 4 includes edge pattern elements 7. The symmetrical parts of the edge pattern 7 line up as shown at point 8.

In accordance with one embodiment, omnidirectional carpet tile having a combination of omnidirectional pattern and non-directional pile enable tiles to be laid in any orientation without pile effects.

What we claim is:

1. A carpet tile having an omnidirectional pattern together with an omnidirectional pile.

2. The carpet tile according to claim 1 in which the omnidirectional pattern has been applied by at least one of dye-injection patterning, tufting with dyed yarns, and weaving with dyed yarns.

3. The carpet tile according to claim 1 in which the omnidirectional pile is created using the method according to U.S. Pat. No. 4,617,208.

4. The carpet tile according to claim 2 in which the omnidirectional pile is created using the method according to U.S. Pat. No. 4,617,208.

5. The carpet tile according to claim 1 in which the omnidirectional pattern is created by the inclusion of a border area which is identical on each edge of the tile and which is symmetrical about the centreline of each edge.

6. The carpet tile according to claim 2 in which the omnidirectional pattern is created by the inclusion of a border area which is identical on each edge of the tile and which is symmetrical about the centreline of each edge.

7. The carpet tile according to claim 3 in which the omnidirectional pattern is created by the inclusion of a border area which is identical on each edge of the tile and which is symmetrical about the centreline of each edge.

8. The carpet tile according to claim 4 in which the omnidirectional pattern is created by the inclusion of a border area which is identical on each edge of the tile and which is symmetrical about the centreline of each edge.
